(19) United States
(12) Patent Application Publication
(10) Pub. No.: US 2007/0258786 A1
(43) Pub. Date: Nov. 8, 2007

(54) Rivet-like fastener with floating nut

(75) Inventors: Thomas Orszagh, Lakeview, NY (US); Adam D. Pratt, Buffalo, NY (US)

Correspondence Address: PHILLIPS LYTLE LLP;INTELLECTUAL PROPERTY GROUP, 3400 HSBC CENTER, BUFFALO, NY, 14203-3509, US

(73) Assignee: Sherex Fastening Solutions, LLC

(21) Appl. No.: 11/416,562

(22) Filed: May 3, 2006

(51) Int. Cl. F16B 13/04

(52) U.S. Cl. 411/34

(57) ABSTRACT

A fastener (20) is adapted to be mounted in a hole provided on a wall (W). The fastener broadly includes an elongated tubular body (21) having a first end (23) and a second end (24), having an outwardly-extending flange (25) adjacent the first end, having an intermediate portion (26), and having a plurality of circularly-shaped longitudinally-extending cantilevered tangs (28, 28, 28, 28) extending from the intermediate portion to the second end. A nut (22) is adapted to be positioned within the cantilevered portions. The nut has an outer polygonal surface (36) and has an internally-threaded through-bore (39). The distal ends of the tangs are plastically deformed or in-turned about the nut to hold the nut within the body.

### TECHNICAL FIELD

The present invention relates generally to the field of fasteners, and, more particularly, to an improved rivet-like fastener having a floating nut that is captured within the in-turned tangs on an elongated tubular body.

### BACKGROUND ART

Fasteners exist in a myriad of different forms and shapes.

With a rivet, a tubular portion is generally passed through an opening in a wall. A head on the rivet engages one side of the wall, and the tubular portion that has passed through the wall opening is thereafter deformed into tight engagement with the wall.

It is sometimes necessary to provide a threaded portion on such a member. Such portion may be either internally threaded, or externally threaded, as desired.

Accordingly, there is believed to be a need for an improved rivet-like fastener having a threaded portion thereon.

### DISCLOSURE OF THE INVENTION

With parenthetical reference to the corresponding parts, portions or surfaces of the disclosed embodiment, merely for purposes of illustration and not by way of limitation, the present invention broadly provides an improved rivet-like fastener (20) that is adapted to be mounted in a hole provided in a wall (W). The improved fastener broadly comprises: an elongated tubular body (21) having a first end (23) and a second end (24), having an outwardly-extending flange (25) adjacent the first end, having an intermediate portion (26), and having a plurality of circularly-spaced longitudinally-extending cantilevered tangs (28, 28, 28, 28) extending from the intermediate portion to the second end, the body also having an abutment surface (33) facing toward the second end; and a nut (22) adapted to be positioned within such cantilevered tangs, the nut having an abutment surface (35) adapted to bear against the body abutment surface, having an outer polygonal surface (36), and having an internally-threaded through-bore (39); and wherein the distal ends of the tangs are adapted to be plastically deformed about the nut to hold the nut within the body.

The body may have an inwardly-facing cylindrical surface (32) adjacent the body abutment surface. The nut may have an axially-extending collar (38) that is adapted to be positioned within the body cylindrical surface. The body may also have a polygonal recess adapted to receive the polygonal portion of the nut to increase the torsional resistance therebetween.

The distal ends of the tangs are in-turned and plastically deformed about the nut to hold the nut within the body. The nut may move radially with respect to the axis of elongation of the body.

The body intermediate portion may be provided with a plurality of circumferentially-spaced longitudinally-extending grooves (43).

The fastener may be placed within a hole in a wall, and the tubular body is deformed into engagement with the wall to prevent unintended removal of the fastener from the hole.

The fastener may further include a headed member having a head portion (44) arranged proximate the deformed tangs and having an externally-threaded shank (45), an intermediate portion of the shank being matingly engaged with the nut, and a marginal end portion (46) of the shank extending beyond the nut.

Accordingly, the general object is to provide an improved fastener.

Another object is to provide an improved rivet-like fastener that is adapted to be deformed into engagement with a portion of a wall about a hole, and having a floating nut captured therewithin.

These and other objects and advantages will become apparent from the foregoing and ongoing written specification, the drawings and the appended claims.

### BRIEF DESCRIPTION OF THE DRAWINGS

FIG. 1 is an isometric view of a first form of the improved fastener, this view showing the nut in exploded aligned relation to the elongated tubular body.

FIG. 2 is a side elevation of the tubular body shown in FIG. 1.

FIG. 3 is a left end elevation of the tubular body shown in FIG. 2.

FIG. 4 is a right end elevation of the tubular body shown in FIG. 2.

FIG. 5 is a side elevation of the nut shown in FIG. 1.

FIG. 6 is a left end elevation of the nut shown in FIG. 5.

FIG. 7 is a right end elevation of the nut shown in FIG. 5.

FIG. 8 is an exploded view, partly in longitudinal vertical section and partly in elevation, showing the nut in exploded aligned relation to the body.

FIG. 9 is a right end elevation of the exploded assembly shown in FIG. 8, and showing the nut as being aligned to fit within the tangs, prior to their being in-turned.

FIG. 10 is a side elevational view of the fastener, showing the distal ends of the tangs as having been in-turned so as to capture the nut.

FIG. 11 is a fragmentary vertical sectional view thereof, taken generally on line 11-11 of FIG. 10, showing the assembled fastener in longitudinal vertical section.

FIG. 12 is an isometric view of the assembly fastener shown in FIGS. 10 and 11.

FIG. 13 is a view of the fastener shown in FIGS. 10-12 as having been passed through aligned openings provided in two plates or wall-like members, and showing an intermediate portion of the body as having been deformed outwardly in rivet-like fashion to hold the two members together.

FIG. 14 is a view similar to FIG. 13, but showing the improved fastener as having passed through an opening in a single plate or wall, with an intermediate portion of the body as having been deformed outwardly in rivet-like fashion to hold the fastener securely to the wall.

FIG. 15 is an isometric view of the improved fastener shown in FIGS. 10-12, albeit in a different orientation, and with a bolt-like member having its head portion arranged within the in-turned tangs, and having its intermediate externally-threaded shank matingly engaging the nut, with having its distal marginal end portion extending therebeyond.

FIG. 16 is a side elevational view of the fastener shown in FIG. 15.

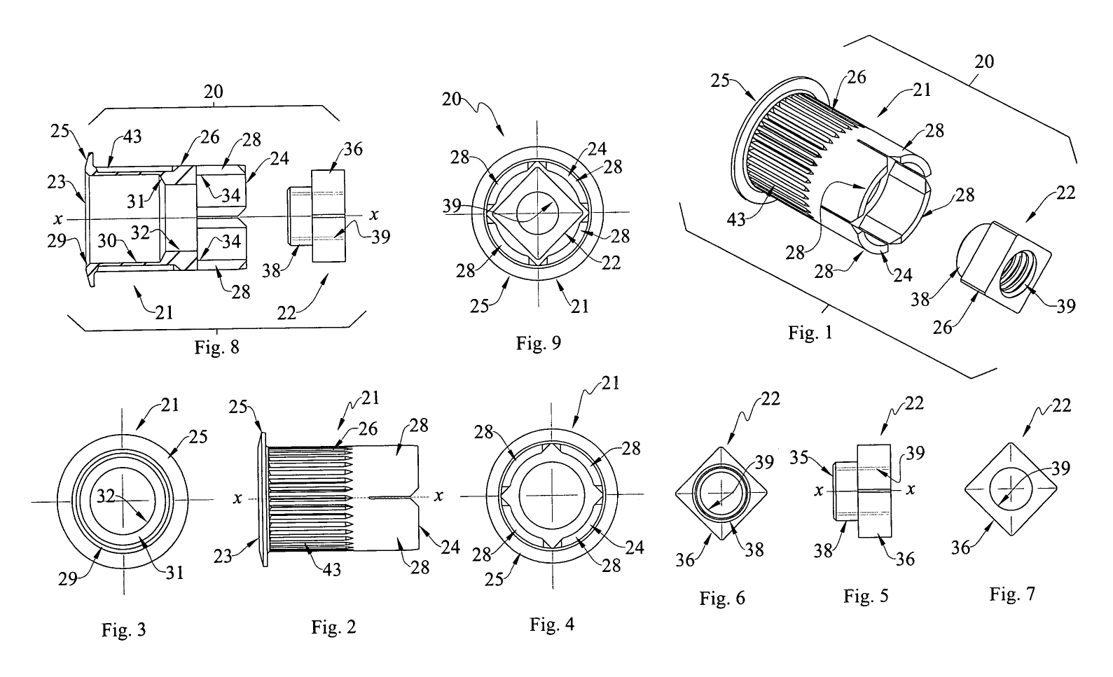

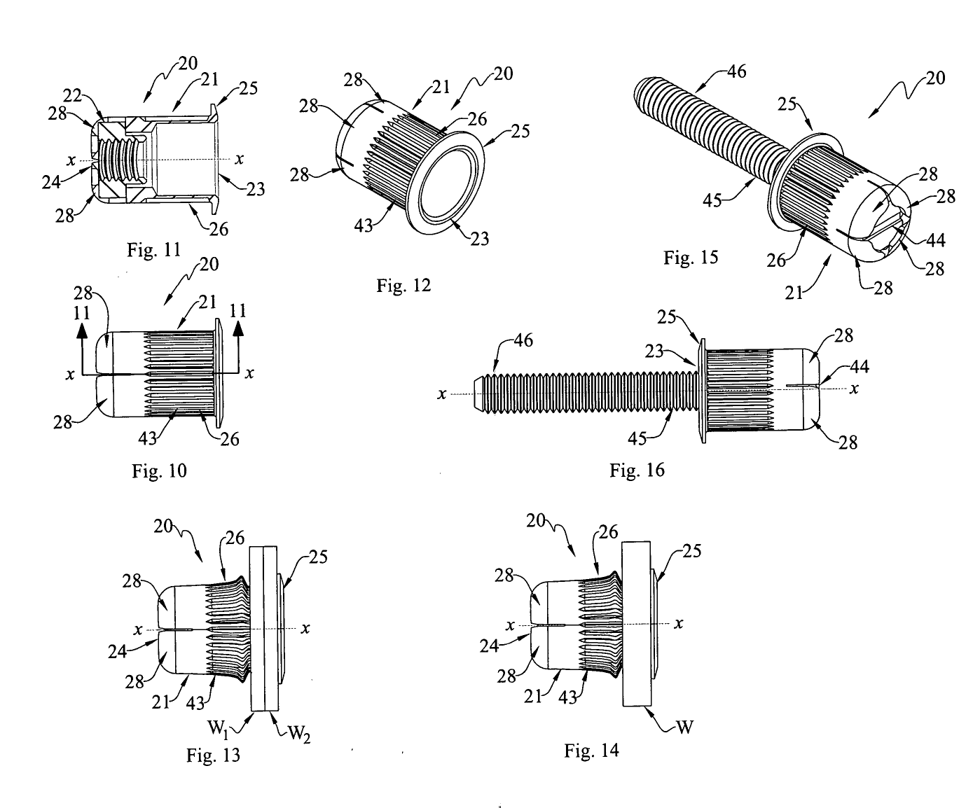

### DESCRIPTION OF THE PREFERRED EMBODIMENTS

At the outset, it should be clearly understood that like reference numerals are intended to identify the same structural elements, portions or surfaces consistently throughout the several drawing figures, as such elements, portions or surfaces may be further described or explained by the entire written specification, of which this detailed description is an integral part. Unless otherwise indicated, the drawings are intended to be read (e.g., cross-hatching, arrangement of parts, proportion, degree, etc.) together with the specification, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

Turning now to the drawings, the present invention broadly provides an improved fastener generally indicated at 20, that is adapted to be operatively mounted in a hole provided in a wall W. Alternatively, the improved fastener may be used to securely hold two plate-like members W₁, W₂ together, as shown in FIG. 13.

The improved fastener is shown as broadly including an elongated tubular body, generally indicated at 21, and a nut, generally indicated at 22.

The tubular body is shown as being a horizontally-elongated member having a first end 23 and a second end 24. A flange 25 extends radially outwardly adjacent the first end. The tubular body has an intermediate portion 26, and has a plurality of circularly-spaced longitudinally-extending cantilevered tangs, severally indicated at 28 extending beyond the intermediate portion in an axial direction.

The body is also shown as having a stepped axial throughbore that sequentially includes, from left-to-right in FIG. 8, an outwardly- and leftwardly-facing frustoconical surface 29 extending rightwardly and inwardly from its left end face, an inwardly-facing horizontal cylindrical surface 30, an inwardly and leftwardly-facing frusto-conical surface 31, an inwardly-facing cylindrical surface 32, a rightwardly-facing annular vertical surface 33, and a plurality of cylindrically-segmented surfaces 34 on the inside of the tangs and continuing rightwardly therefrom to join the right end face of the body. Surface 33 constitutes an abutment surface facing toward the second end.

The nut is shown as being an elongated tubular member, and has a leftward abutment surface 35 adapted to face toward, and to bear against, body abutment surface 33. The nut also has an outer polygonal surface 36. In the illustrated embodiment, the nut also has a leftwardly-extending cylindrical collar 38. The collar and nut have an internally-threaded through-bore indicated at 39.

The nut is adapted to be positioned within the tubular body such that the tubular collar 38 fits within body cylindrical surface 32, with nut abutment surface 35 being arranged to face toward, and to bear against, body abutment surface 33. The body may have a complimentarily-configured polygonal recess which is adapted to receive the polygonal portion of the nut so as to increase the torsional resistance between the body and nut. These polygonal recess and portion may be rectangular, hexagonal, half-hexagonal, or some other polygonal shape or configuration. Thereafter, the distal marginal end portions of the tangs are plastically deformed, or in-turned, to capture the nut within the body, as shown in FIG. 11.

The improved fastener is adapted to be positioned within the hole provided in a wall, such as indicated at W in FIG. 14, or as to pass through aligned openings provided in a pair of plates, indicated at W₁, W₂, as shown in FIG. 13. If desired, the tubular body may be plastically deformed so as to bow an intermediate portion, indicated at 42, outwardly into rivet-like engagement with the wall. Thus, in this form, the fastener has a rivet-like tubular body that is deformed into engagement with the wall. The nut is then accessible from either the left or right end of the fastener.

The body may be provided with a plurality of longitudinally-extending circumferentially-spaced grooves, severally indicated at 43, to enhance its engagement with the wall or walls in which it is mounted.

Referring now to FIGS. 15 and 16, a bolt- or screw-like member, depending on terminology, may be operatively associated with the improved fastener. In this form, the member has a head portion, indicated at 44 arranged adjacent the in-turned ends of the body, and has an externally-threaded shank 45. A portion of the shank matingly engages the nut. The distal end portion 46 of the shank can extend pass the first end face of the fastener for engagement by another internally-threaded member (not shown).

Therefore, the present invention broadly provides an improved fastener that is adapted to be mounted in the hole provided through a wall. The improved fastener broadly includes an elongated tubular body, and a nut captured between the in-turned tangs of the body. The fastener may optically include a bolt- or screw-like member matingly engaged with the nut and having a threaded shank portion extending there-beyond.

Modifications

The present invention contemplates that may changed and modifications may be made. For example, the particular shape and configuration of the nut and body may be changed or modified. In the illustrated form, the nut is shown as having a square polygonal surface. However, this could be hexagonal or some other polygonal shape, as desired. The presence of the collar, which serves to generally locate the nut relative to the body, is optional and may be omitted. The materials of construction are not deemed to be critical, and may be changed or modified, as desired. Similarly, the size, proportion and threads of the nut and bolt- or screw-like member may also be changed or modified, as desired. Depending upon the extend of frictional engagement with the in-turned tangs, the nut may float, or move radially, relative to the body within the confines of the tangs, or not, as desired.

Therefore, while presently-preferred forms of the improved fastener have been shown and described, and several modifications thereof discussed, persons skilled in this art will readily appreciate that various additional changes and modifications may be made, without departing from the spirit of the invention, as defined and differentiated by the following claims.

What is claimed is:

1. A fastener adapted to be mounted in a hole provided in a wall, comprising:
an elongated tubular body having a first end and a second end, having an outwardly-extending flange adjacent said first end, having an intermediate portion, and having a plurality of circularly-spaced longitudinally-extending cantilevered tangs extending from said intermediate portion to said second end, said body also having an abutment surface facing toward said second end; and
a nut adapted to be positioned within such cantilevered tangs, said nut having an abutment surface adapted to bear against said body abutment surface, having an outer polygonal surface, and having an internally-threaded through-bore; and
wherein the distal ends of said tangs are adapted to be plastically deformed about said nut to hold said nut within said body.

2. A fastener as set forth in claim 1 wherein said body has an inwardly-facing cylindrical surface adjacent said body abutment surface.

3. A fastener as set forth in claim 2 wherein said nut has an axially-extending collar.

4. A fastener as set forth in claim 3 wherein said collar is arranged within said body cylindrical surface.

5. A fastener as set forth in claim 1 wherein the distal ends of said tangs are plastically deformed about said nut to hold said nut within said body.

6. A fastener as set forth in claim 5 wherein said nut may move radially with respect to the axis of elongation of said body.

7. A fastener as set forth in claim 1 wherein said body intermediate portion is provided with a plurality of circumferentially-spaced longitudinally-extending grooves.

8. A fastener as set forth in claim 1 wherein said fastener is placed within a hole in a wall, and said tubular body is deformed into engagement with said wall to prevent unintended removal of said fastener from said hole.

9. A fastener as set forth in claim 5 and further comprising a headed member having a head portion arranged proximate said deformed tangs and having an externally-threaded shank, an intermediate portion of said shank being matingly engaged with said nut, and a marginal end portion of said shank extending beyond said nut.

10. A fastener as set forth in claim 1 wherein said body has a polygonal recess adapted to receive the polygonal surface of said nut to increase the torsional resistance between said body and nut.
